(19) United States
(12) Patent Application Publication
(10) Pub. No.: US 2024/0311701 A1
(43) Pub. Date: Sep. 19, 2024

(54) APPARATUS, METHOD AND COMPUTER PROGRAM FOR DERIVING DIGITAL TWIN MODEL

(71) Applicant: STANS INC., Seoul (KR)

(72) Inventors: Ji Hye JEON, Seoul (KR); Jong Ho BAIK, Namyangju-si Gyeonggi-do (KR)

(73) Assignee: STANS INC., Seoul (KR)

(21) Appl. No.: 18/678,625

(22) Filed: May 30, 2024

Related U.S. Application Data
(63) Continuation of application No. PCT/KR2022/017824, filed on Nov. 14, 2022.

(30) Foreign Application Priority Data
Dec. 13, 2021 (KR) 10-2021-0177733

(51) Int. Cl. G06N 20/00; G06N 7/01; G06Q 10/04

(52) U.S. Cl. CPC G06N 20/00; G06N 7/01; G06Q 10/04

(57) ABSTRACT

An apparatus configured to drive a digital twin model includes a data collection unit configured to collect sensing data from a plurality of sensors mapped to a plurality of digital twin models for a target area to be managed, a preprocessing unit configured to generate a hierarchical data set assigned with a weight by performing a preprocessing process on the collected sensing data, and a derivation unit configured to derive information about at least one digital twin model corresponding to the hierarchical data set among the plurality of digital twin models by using a pre-trained classification model.

### CROSS-REFERENCE TO RELATED APPLICATIONS

This application is a continuation of International Application No. PCT/KR2022/017824 filed on Nov. 14, 2022, which claims priority to Korean Patent Application No. 10-2021-0177733 filed on Dec. 13, 2021, the entire contents of which are herein incorporated by reference.

### TECHNICAL FIELD

The present disclosure relates to an apparatus, method and computer program for deriving a digital twin model.

### BACKGROUND

A digital twin refers to a technology for creating a twin in a computer to correspond to an object in a real world and simulating situations that may occur in the real world using the computer so as to predict results in advance. The digital twin is a digital object that can be used to optimize the physical world, and is attracting attention as a technology that can significantly improve operational performance and business processes and thus can solve various problems in industrial and social fields as well as in a manufacturing field.

In regard to the digital twin, Korean Patent No. 10-2067095, which is prior art, discloses a digital twin device.

Recently, the digital twin has been applied to a building management system (BMS). Thus, it possible to predict disaster events, which can happen in a building, in advance through simulations. Also, since disaster events, which can happen in a building, can be predicted in advance, it is possible for a manager to prevent the occurrence of events.

### SUMMARY OF THE INVENTION

### Problems to be Solved by the Invention

The present disclosure is conceived to provide an apparatus, method and computer program for generating a hierarchical data set or a weighted hierarchical data set by collecting sensing data from a plurality of sensors mapped to a plurality of digital twin models for a target area to be managed and performing a preprocessing process on the collected sensing data.

The present disclosure is conceived to provide an apparatus, method and computer program for deriving information about at least one digital twin model corresponding to a hierarchical data set among a plurality of digital twin models by using a pre-trained classification model.

The present disclosure is conceived to provide an apparatus, method and computer program for generating visual information based on information about a digital twin model.

However, the problems to be solved by the present disclosure are not limited to the above-described problems. There may be other problems to be solved by the present disclosure.

### Means for Solving the Problems

According to an exemplary embodiment, an apparatus configured to drive a digital twin model, comprising: a data collection unit configured to collect sensing data from a plurality of sensors mapped to a plurality of digital twin models for a target area to be managed; a preprocessing unit configured to generate a hierarchical data set assigned with a weight by performing a preprocessing process on the collected sensing data; and a derivation unit configured to derive information about at least one digital twin model corresponding to the hierarchical data set among the plurality of digital twin models by using a pre-trained classification model.

According to another exemplary embodiment, a method for deriving a digital twin model, which is performed by an apparatus configured to drive a digital twin model, comprising: a process of collecting sensing data from a plurality of sensors mapped to a plurality of digital twin models for a target area to be managed; a process of generating a hierarchical data set assigned with a weight by performing a preprocessing process on the collected sensing data; and a process of deriving information about at least one digital twin model corresponding to the hierarchical data set among the plurality of digital twin models by using a pre-trained classification model.

According to another exemplary embodiment, a computer program stored in a computer-readable medium including a sequence of instructions to derive a digital twin model, which when executed by a computing device, causes the computing device to: collect sensing data from a plurality of sensors mapped to a plurality of digital twin models for a target area to be managed; generate a hierarchical data set assigned with a weight by performing a preprocessing process on the collected sensing data; and derive information about at least one digital twin model corresponding to the hierarchical data set among the plurality of digital twin models by using a pre-trained classification model.

The above-described exemplary embodiments are provided by way of illustration only and should not be construed as liming the present disclosure. Besides the above-described exemplary embodiments, there may be additional exemplary embodiments described in the accompanying drawings and the detailed description.

### Effects of the Invention

According to any one of the above-described means for solving the problems of the present disclosure, it is possible to provide an apparatus, method and computer program for generating a hierarchical data set by collecting sensing data from a plurality of sensors mapped to a plurality of digital twin models for a target area to be managed, such as an underground utility tunnel, and performing a preprocessing process on the collected sensing data. This makes it possible to determine which of the plurality of digital twin models is used to determine the occurrence of a management event.

Also, it is possible to provide an apparatus, method and computer program for generating a weighted hierarchical data set based on a hierarchical structure between sensors by assigning different weights to respective sensing data based on a sensor, which has a dominant effect in determining a specific event, among a plurality of sensors mapped to a specific digital twin model and performing a preprocessing process on the sensing data.

Further, it is possible to provide an apparatus, method and computer program for deriving information about at least one digital twin model corresponding to a hierarchical data set among a plurality of digital twin models by using a pre-trained classification model, specifying a specific digital twin model among a plurality of digital twin models, and deriving a probability value for the specific digital twin model.

Furthermore, it is possible to provide an apparatus, method and computer program for generating visual information for visualizing the occurrence of a management event managed by a digital twin model by dynamically generating visual information based on a probability value for the digital twin model and adjusting the size and transparency of the visual information.

### BRIEF DESCRIPTION OF THE DRAWINGS

FIG. 1 is a configuration view of an apparatus according to an embodiment of the present disclosure.

FIG. 2 is an exemplary diagram illustrating a plurality of sensors mapped to a plurality of digital twin models according to an embodiment of the present disclosure.

FIG. 3 is an exemplary diagram illustrating visual information which is generated based on information about a digital twin model according to an embodiment of the present disclosure.

FIG. 4 is a flowchart showing a method for generating visual information of a digital twin model which is performed by the apparatus according to an embodiment of the present disclosure.

FIG. 5 is a flowchart showing a method for deriving a digital twin model which is performed by the apparatus according to an embodiment of the present disclosure.

### DETAILED DESCRIPTION OF THE INVENTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

Throughout this document, the term “unit” includes a unit implemented by hardware and/or a unit implemented by software. As examples only, one unit may be implemented by two or more pieces of hardware or two or more units may be implemented by one piece of hardware.

In the present specification, some of operations or functions described as being performed by a device may be performed by a server connected to the device. Likewise, some of operations or functions described as being performed by a server may be performed by a device connected to the server.

Hereinafter, the present disclosure will be explained in detail with reference to the accompanying configuration views or process flowcharts.

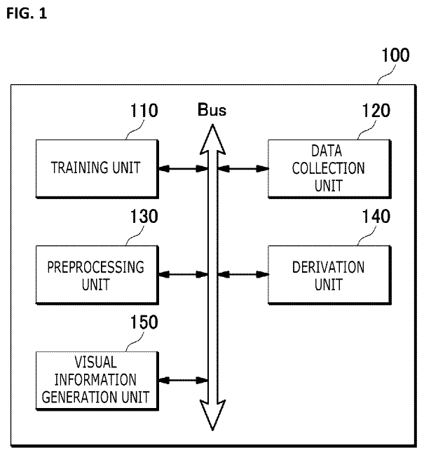

FIG. 1 is a configuration view of an apparatus according to an embodiment of the present disclosure. Referring to FIG. 1, an apparatus 100 may include a training unit 110, a data collection unit 120, a preprocessing unit 130, a derivation unit 140, and a visual information generation unit 150. The apparatus 100 may include one or more processors and one or more memory modules storing programs. The training unit 110, the data collection unit 120, the preprocessing unit 130, the derivation unit 140, and the visual information generation unit 150 may be program modules in the form of operating systems, application program modules, and other program modules stored in the memory modules. Such program modules may include, but are not limited to, routines, subroutines, programs, objects, components, and data structures for performing specific tasks or executing specific abstract data types according to the invention as will be described below.

The data collection unit 120 may collect sensing data from a plurality of sensors mapped to a plurality of digital twin models for a target area to be managed. Herein, the target area to be managed may be an underground utility tunnel, such as a subway station, and may include regions of various buildings, but is not limited thereto.

A digital twin model refers to a technology for creating a twin in a computer to correspond to an object in a real world and simulating situations that may occur in the real world using the computer so as to predict results in advance. For example, the digital twin model may be a model which enables simulation of disaster situations that can happen in an underground utility tunnel. Hereinafter, the digital twin model will be described briefly. The digital twin model may be a model which enables prediction or simulation of the occurrence of a specific event related to disasters (e.g., fire, flood, earthquake, and the like) in a target area to be managed, such as an underground utility tunnel. The digital twin model may be created based on management data, dynamic model data, simulation data, sensing data, and space object data related to an event to be predicted or simulated.

Each digital twin model may be mapped to each sensor associated with the digital twin model.

Each digital twin model may receive sensing data collected from the sensor mapped to the digital twin model and predict or simulate the occurrence of a specific event. Herein, a plurality of digital twin models corresponding to a plurality of specific events to be predicted or simulated may be generated in advance.

Each digital twin model may include space object data corresponding to first basic data for the target area, sensing data corresponding to second basic data, simulation data corresponding to third basic data, dynamic model data corresponding to fourth basic data, and management data corresponding to fifth basic data.

The space object data are defined for one object, and may refer to, for example, spatial information or object data for expressing an underground utility tunnel, which is a target area. The sensing data are measured by a plurality of sensors, and may refer to, for example, data measured by a plurality of sensors installed in the underground utility tunnel, which is the target area. The simulation data are predictive or required data generated through simulations, and may refer to, for example, data applied to virtual simulations for predicting a risk of the underground utility tunnel, which is the target area. The dynamic model data are used to create a digital twin model for a behavior or a service for each user, and may refer to, for example, data for behavior and response of each user to each situation, i.e., a dynamic service provided to a space and a user in the underground utility tunnel, which is the target area. The management data are relevant or linked organizations and management data for responding to a risk situation, and may refer to, for example, data of an organization that manages the underground utility tunnel, which is the target area.

Each digital twin model may be generated by combining the first to fifth basic data. For example, service information data are generated by combining the space object data corresponding to the first basic data with the sensing data corresponding to the second basic data, prediction spread data are generated by combining the service information data with the simulation data corresponding to the third basic data, prevention response data are generated by combining the prediction spread data with the dynamic model data corresponding to the fourth basic data, and disaster management data are generated by combining the prevention response data with the management data corresponding to the fifth basic data to generate each digital twin model.

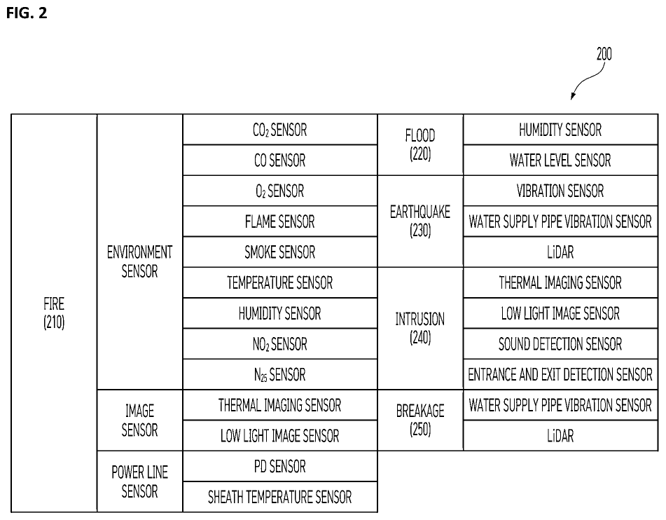

A process of collecting sensing data from a plurality of sensors mapped to a plurality of digital twin models will be described in detail with reference to FIG. 2.

FIG. 2 is an exemplary diagram illustrating a plurality of sensors mapped to a plurality of digital twin models according to an embodiment of the present disclosure. Referring to FIG. 2, a plurality of digital twin models 200 may include, for example, a fire digital twin model 210, a flood digital twin model 220, an earthquake digital twin model 230, and an intrusion digital twin model 240, a breakage digital twin model 250, and the like.

The data collection unit 120 may collect sensing data from a plurality of sensors mapped to a plurality of digital twin models for a target area to be managed. Herein, the sensing data may include a sensing value for each of the plurality of sensors and location information (e.g., BF2/second region/third sector, and the like) of the corresponding sensor.

For example, the data collection unit 120 may collect sensing data from each of an environment sensor, an image sensor, and a power line sensor mapped to the fire digital twin model 210 for the target area. Herein, the environment sensor may include, for example, a CO₂ sensor, a CO sensor, an O₂ sensor, a flame sensor, a smoke sensor, a temperature sensor, a humidity sensor, a NO₂ sensor, an H₂₅ sensor, and the like. Also, the image sensor may include a thermal imaging sensor, a low light image sensor, and the like. Further, the power line sensor may include a PD sensor, a sheath temperature sensor, and the like.

For another example, the data collection unit 120 may collect sensing data from a humidity sensor, a water level sensor, and the like mapped to the flood digital twin model 220 for the target area

For yet another example, the data collection unit 120 may collect sensing data from a vibration sensor, a water supply pipe vibration sensor, a LiDAR, and the like mapped to the earthquake digital twin model 230 for the target area.

For still another example, the data collection unit 120 may collect sensing data from a thermal imaging sensor, a low light image sensor, a sound detection sensor, an entrance and exit detection sensor, and the like mapped to the intrusion digital twin model 240 for the target area.

For still another example, the data collection unit 120 may collect sensing data from a water supply pipe vibration sensor, a LiDAR, and the like mapped to the breakage digital twin model 250 for the target area.

Referring back to FIG. 1, the apparatus 100 may derive information about a digital twin model corresponding to a hierarchical data set generated based on the sensing data among the plurality of generated digital twin models according to a first embodiment.

The preprocessing unit 130 may generate a hierarchical data set by performing a preprocessing process on the collected sensing data. Herein, the hierarchical data set is a data set based on sensing data randomly generated in real time, and may include location information of a sensor which has generated the sensing data. The preprocessing unit 130 may generate a hierarchical data set to train a classification model to be described later, or generate a hierarchical data set to derive a specific digital twin model corresponding to a real-time field situation.

For example, suppose that there are three digital twin models and five sensors, such as sensor A, sensor B, sensor C, sensor D and sensor E, for the target area, and digital twin model 1 is mapped to sensor A, sensor B and sensor D, digital twin model 2 is mapped to sensor A, sensor D and sensor E, and digital twin model 3 is mapped to sensor B, sensor D, sensor E and sensor F. In this case, the preprocessing unit 130 may generate a hierarchical data set configured by a data format corresponding to “sensor A value/sensor B value/sensor C value/sensor D value/sensor E value”.

The training unit 110 may generate a training data set based on the sensing data collected from the plurality of sensors in order to initially train the classification model. Specifically, the training unit 110 may generate a training data set by combining hierarchical data set generated by using the collected sensing data with an identification number (class value) of a digital twin model corresponding to the hierarchical data set among the plurality of digital twin models. Herein, the training data set may be an answer data set generated based on sensing data collected when a specific disaster situation is artificially recreated in the field of the target area.

For example, the data collection unit 120 may collect sensing data measured by the plurality of sensors through recreation of a specific disaster situation managed by digital twin model F in the field of the target area. Then, the preprocessing unit 130 may generate a hierarchical data set configured by a data format corresponding to “sensor A value/sensor B value/sensor C value/sensor D value/sensor E value” based on the collected sensing data. Also, the training unit 110 may generate a training data set by combining a hierarchical data set with an identification number (class value) of digital twin model F corresponding to the hierarchical data set.

The training unit 110 may input a training data set into the classification model and train the classification model to derive an optimum coefficient value required to classify a specific digital twin model corresponding to the input training data set based on the training data set among the plurality of digital twin models. For example, the training unit 110 may input, into the classification model, a training data set composed of “sensor A value/sensor B value/sensor C value/sensor D value/sensor E value/identification number of digital twin model F” and train the classification model to derive an optimum coefficient value required to classify a hierarchical data set included in the input training data set as digital twin model F among the plurality of digital twin models.

Through this process, the training unit may receive a training data set corresponding to each of the plurality of digital twin models and derive an optimum coefficient value to classify each digital twin model and thus train the classification model.

After the initial training of the classification model is completed, the training unit 110 may update the pre-trained classification model in real time based on sensing data collected from a situation being actually monitored.

The derivation unit 140 may derive information about at least one digital twin model corresponding to the hierarchical data set among the plurality of digital twin models by using the pre-trained classification model.

For example, the preprocessing unit 130 may generate a hierarchical data set by using sensing data collected in real time to derive a specific digital twin model corresponding to the current actual situation, and the derivation unit 140 may input the generated hierarchical data set into the pre-trained classification model and derive class information (e.g., a class value corresponding to a digital twin model name) of a digital twin model corresponding to the hierarchical data set among the plurality of digital twin models and a probability value (e.g., a probability value for the corresponding class) of the occurrence of a management event (e.g., fire, flood, earthquake, breakage, and the like) managed by the digital twin model.

For another example, the derivation unit 140 may derive a plurality of probability values of the occurrence of management events managed by the plurality of digital twin models, respectively, by using the classification model into which the hierarchical data set is input.

According to a second embodiment, the apparatus 100. the preprocessing unit 130 may derive information about a digital twin model corresponding to a hierarchical data set assigned with a weight generated based on sensing data among a plurality of generated digital twin models. The preprocessing unit 130 may assign a plurality of test weight sets to the training data set generated as described above. For example, the preprocessing unit 130 may assign a test weight set (e.g., “sensor A value: 0.4/sensor B value: 0.9/sensor C value: 0.1/sensor D value: 0.0/sensor E value: 0.1”) including random weights for respective sensing data to a training data set composed of “sensor A value/sensor B value/sensor C value/sensor D value/sensor E value/identification number of digital twin model F”. Also, the training unit 110 may input a plurality of training data sets assigned with a plurality of test weight sets into the classification model and train the classification model to derive optimum coefficient values in order to initially train the classification model.

The preprocessing unit 130 may derive a training data set corresponding to the optimum coefficient value with the highest score from the classification model among the plurality of training data sets assigned with the plurality of test weight sets, and may set a test weight set assigned to the derived training set as an optimum weight set for a digital twin model corresponding to class information included in the derived training data set. That is, the optimum weight set may be derived together with the optimum coefficient value in the process of training the classification model.

The preprocessing unit 130 may set an optimum weight set for each of the plurality of digital twin models by repeatedly performing the above-described operation to each of the plurality of digital twin models. For example, if there are ten digital twin models for the target area, the preprocessing unit 130 may derive ten optimum weight sets corresponding to each digital twin model.

This is to theoretically derive that sensing data from which sensor among a plurality of sensors installed in the target area are dominant in a specific disaster situation and assign different weights to the plurality of sensors, respectively. Through this process, the classification model can derive information about a digital twin model with high accuracy by assigning a weight to a sensor having the most dominant effect among sensors mapped to respective digital twin models.

Thereafter, the preprocessing unit 130 may generate a weighted hierarchical data set by performing a preprocessing process on sensing data collected in real time to derive a specific digital twin model corresponding to the current actual situation. In this case, the preprocessing unit 130 may assign the generated hierarchical data set with a plurality of optimum weight sets corresponding to a plurality of digital twin models. For example, if there are five digital twin models for the target area, the preprocessing unit 130 may generate a hierarchical data set based on the sensing data collected in real time and assign a hierarchical data set with each of a total of five optimum weight sets corresponding to each digital twin model. The derivation unit 140 may input, into the pre-trained classification model, five hierarchical data sets assigned with optimum weights corresponding to respective models, and the pre-trained classification model may derive a digital twin model name (class value) with the highest classification possibility and a probability value (e.g., a probability value for the corresponding class) predicted for a specific situation from the corresponding digital twin model. In this case, the probability value predicted from each digital twin model may be output.

Accordingly, the preprocessing unit 130 may generate a hierarchical data set in which sensing data randomly generated by a plurality of sensors are rearranged in consideration of a weight for each sensor.

Through this preprocessing process, when sensing data A to sensing data Z are collected in real time from the plurality of sensors for the target area to be managed, the sensing data are preprocessed to arrange big data. Thus, a hierarchical data set assigned with a weight can be generated.

If the preprocessing process is not performed, it becomes difficult to determine which of the plurality of digital twin models is used to determine the occurrence of a management event, based on the randomly generated sensing data A or sensing data Z.

Also, different weights may be assigned to respective sensing data based on the finding that there is a sensor, which has a dominant effect in determining whether a management event has occurred, among a plurality of sensors mapped to a specific digital twin model. Thus, a hierarchical data set can be generated so that the plurality of sensors has a hierarchical structure.

The derivation unit 140 may derive information about at least one digital twin model corresponding to the hierarchical data set among the plurality of digital twin models by using the pre-trained classification model.

For example, the derivation unit 140 may input a hierarchical data set assigned with an optimum weight set into the classification model. The derivation unit 140 may derive class information (a class value corresponding to a digital twin model name) of a digital twin model corresponding to the hierarchical data set among the plurality of digital twin models and a probability value (a probability value for the corresponding class) for the digital twin model by using the classification model.

For example, if there are five digital twin models for the target area, the preprocessing unit 130 may set an optimum weight set for each of the five digital twin models. In this case, if sensing data are collected in real time, the preprocessing unit 130 may assign the optimum weight set for each of the five digital twin models to the sensing data and generate a total of five hierarchical data sets corresponding to the respective digital twin models.

Then, when the derivation unit 140 inputs, into the classification model, the five hierarchical data sets assigned with the optimum weight sets corresponding to the respective models, the classification model may output a specific digital twin model with the highest classification possibility among the plurality of digital twin models and a probability value for the corresponding class or may output a probability value predicted for each of the five digital twin models.

The visual information generation unit 150 may generate visual information based on information about s digital twin model. Herein, the visual information generation unit 150 may generate visual information for each digital twin model based on information about a plurality of digital twin models. For example, if five digital twin models are generated, visual information may be generated for each of the five digital twin models.

The visual information generation unit 150 may generate visual information to visualize whether a management event managed by a digital twin model corresponding to a hierarchical data set has occurred, based on the class information and probability value derived by the derivation unit 140. Herein, the visual information generation unit 150 may adjust size information and transparency information of the visual information to reflect the probability value.

For example, the visual information generation unit 150 may specify a specific digital twin model among the plurality of digital twin models based on the class information and probability value derived by the derivation unit 140, specify the location of a sensor based on location information included in a hierarchical data set corresponding to the specific digital twin model, and generate visual information to visualize whether a management event has occurred based on a probability value of the occurrence of a management event in the specific digital twin model. For another example, if there is a plurality of hierarchical data sets generated by the preprocessing unit 130, the visual information generation unit 150 may generate visual information to simultaneously visualize probability values of the occurrence of management events in digital twin models corresponding to hierarchical data sets, respectively.

That is, according to the present disclosure, visual information which reflects a probability value derived for each digital twin model is output instead of sensing data exceeding a threshold value, and, thus, it is possible to visualize the occurrence of even a minor accident event. Also, it is possible to perform visualization to make it easy to prevent the occurrence of an accident event. Therefore, it is possible for a manager to be aware of all accident events which are likely to occur in the current situation.

The visual information generation unit 150 may generate a monitoring image of the target area and display visual information of a region corresponding to the location information in the target area based on the monitoring image.

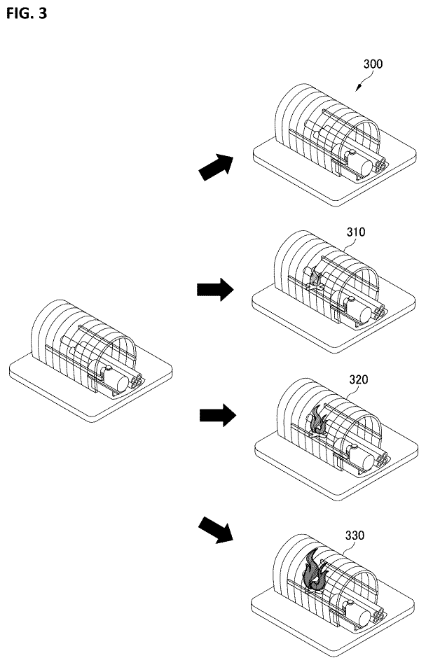

For example, the visual information generation unit 150 may generate visual information to visualize whether a management event managed by each of a plurality of digital twin models has occurred, based on a plurality of probability values derived by the derivation unit 140. Herein, the visual information generation unit 150 may overlay the visual information about the management event managed by each of a plurality of digital twin models on the monitoring image of the target area for each of the plurality of digital twin models. The process of generating visual information will be described in detail with reference to FIG. 3.

FIG. 3 is an exemplary diagram illustrating visual information which is generated based on information about a digital twin model according to an embodiment of the present disclosure. Referring to FIG. 3, if the derivation unit 140 derives class information of a digital twin model corresponding to a hierarchical data set among a plurality of digital twin models for an underground utility tunnel, which is a target area to be managed, and a probability value of the occurrence of a management event managed by the digital twin model, the visual information generation unit 150 may generate visual information to visualize whether a management event managed by the digital twin model corresponding to the hierarchical data set has occurred, based on the probability value of the occurrence of the management event managed by the digital twin model.

For example, when a probability value of the occurrence of a fire event is 0%, the visual information generation unit 150 may not display visual information corresponding to a fire in a region corresponding to location information in the target area or may generate visual information while adjusting the size of the visual information to “small” and the transparency to “100%” to display only the outline of the generated visual information in a region corresponding to location information in the target area (see reference numeral 300).

For another example, when a probability value of the occurrence of a fire event is less than 30%, the visual information generation unit 150 may generate visual information corresponding to a fire while adjusting the size of the visual information to “small” and the transparency to “80%” to display the generated visual information in a region corresponding to location information in a target area (e.g., basement second floor/second area/third sector) (see reference numeral 310).

For yet another example, when a probability value of the occurrence of a fire event is less than 60%, the visual information generation unit 150 may generate visual information corresponding to a fire while adjusting the size of the visual information to “medium” and the transparency to “50%” to display the generated visual information in a region corresponding to location information in the target area (see reference numeral 320).

For still another example, when a probability value of the occurrence of a fire event is less than 90%, the visual information generation unit 150 may generate visual information corresponding to a fire while adjusting the size of the visual information to “large” and the transparency to “10%” to display the generated visual information in a region corresponding to location information in the target area (see reference numeral 330).

The apparatus 100 may be executed by a computer program stored in a medium including a sequence of instructions for generating visual information of a digital twin model. When executed by a computing device, the computer program causes the computing device to collect sensing data from a plurality of sensors mapped to a plurality of digital twin models for a target area to be managed, generate a hierarchical data set by performing a preprocessing process on the collected sensing data, derive information about at least one digital twin model corresponding to the hierarchical data set among the plurality of digital twin models by using a pre-trained classification model, and generate visual information based on the information about the digital twin model.

Also, the apparatus 100 may be executed by a computer program stored in a medium including a sequence of instructions for deriving a digital twin model. When executed by a computing device, the computer program causes the computing device to collect sensing data from a plurality of sensors mapped to a plurality of digital twin models for a target area to be managed, generate a hierarchical data set assigned with a weight by performing a preprocessing process on the collected sensing data, and derive information about at least one digital twin model corresponding to the hierarchical data set among the plurality of digital twin models by using a pre-trained classification model.

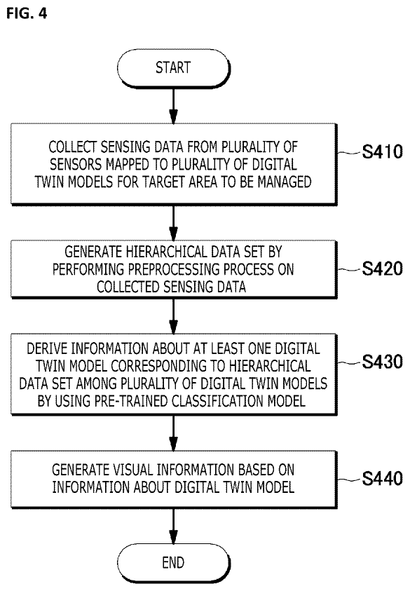

FIG. 4 is a flowchart showing a method for generating visual information of a digital twin model which is performed by the apparatus according to an embodiment of the present disclosure. Referring to FIG. 4, the method for generating visual information of a digital twin model which is performed by the apparatus 100 includes the processes time-sequentially performed according to the embodiments illustrated in FIG. 1 to FIG. 3. Therefore, the above descriptions of the processes may also be applied to the method for generating visual information of a digital twin model which is performed by the apparatus 100 according to the embodiments illustrated in FIG. 1 to FIG. 3 even though they are omitted hereinafter.

In a process S410, the apparatus 100 may collect sensing data from a plurality of sensors mapped to a plurality of digital twin models for a target area to be managed.

In a process S420, the apparatus 100 may generate a hierarchical data set by performing a preprocessing process on the collected sensing data.

In a process S430, the apparatus 100 may derive information about at least one digital twin model corresponding to the hierarchical data set among the plurality of digital twin models by using a pre-trained classification model.

In a process S440, the apparatus 100 may generate visual information based on the information about the digital twin model.

In the descriptions above, the processes S410 to S440 may be divided into additional processes or combined into fewer processes depending on an embodiment. In addition, some of the processes may be omitted and the sequence of the processes may be changed if necessary.

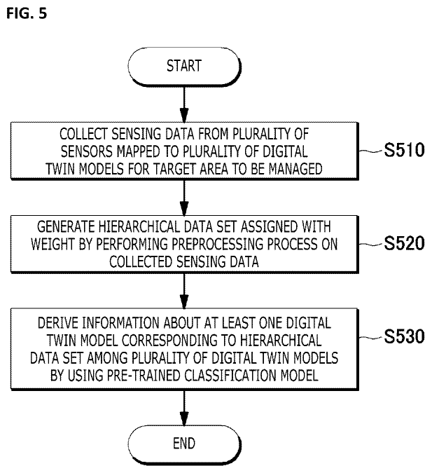

FIG. 5 is a flowchart showing a method for deriving a digital twin model which is performed by the apparatus according to an embodiment of the present disclosure. Referring to FIG. 5, the method for deriving a digital twin model which is performed by the apparatus 100 includes the processes time-sequentially performed according to the embodiments illustrated in FIG. 1 to FIG. 4. Therefore, the above descriptions of the processes may also be applied to the method for deriving a digital twin model which is performed by the apparatus 100 according to the embodiments illustrated in FIG. 1 to FIG. 4 even though they are omitted hereinafter.

In a process S510, the apparatus 100 may collect sensing data from a plurality of sensors mapped to a plurality of digital twin models for a target area to be managed.

In a process S520, the apparatus 100 may generate a hierarchical data set assigned with a weight by performing a preprocessing process on the collected sensing data.

In a process S530, the apparatus 100 may derive information about at least one digital twin model corresponding to the hierarchical data set among the plurality of digital twin models by using a pre-trained classification model.

In the descriptions above, the processes S510 to S540 may be divided into additional processes or combined into fewer processes depending on an embodiment. In addition, some of the processes may be omitted and the sequence of the processes may be changed if necessary.

The method for deriving a digital twin model and the method for generating visual information of the digital twin model by the apparatus described above with reference to FIG. 1 to FIG. 5 can be implemented as a computer program stored in a medium to be executed by a computer or a storage medium including instructions executable by a computer. Also, the method for deriving a digital twin model and the method for generating visual information of the digital twin model by the apparatus described above with reference to FIG. 1 to FIG. 5 can be implemented as a computer program stored in a medium to be executed by a computer.

A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.
100: Apparatus
110: Training unit
120: Data collection unit
130: Preprocessing unit
140: Derivation unit
150: Visual information generation unit

We claim:

1. An apparatus configured to drive a digital twin model, comprising:
a data collection unit configured to collect sensing data from a plurality of sensors mapped to a plurality of digital twin models for a target area to be managed;
a preprocessing unit configured to generate a hierarchical data set assigned with a weight by performing a preprocessing process on the collected sensing data; and
a derivation unit configured to derive information about at least one digital twin model corresponding to the hierarchical data set among the plurality of digital twin models by using a pre-trained classification model.

2. The apparatus of claim 1,
wherein the preprocessing unit assigns the generated hierarchical data set with a plurality of optimum weight sets corresponding to the plurality of digital twin models, and
the derivation unit inputs the hierarchical data set assigned with the optimum weight sets into the classification model.

3. The apparatus of claim 2,
wherein the derivation unit derives class information of a digital twin model corresponding to the hierarchical data set assigned with the optimum weight sets among the plurality of digital twin models by using the classification model and a probability value for the digital twin model.

4. The apparatus of claim 1, further comprising:
a training unit configured to generate a training data set by combining class information of a digital twin model corresponding to the hierarchical data set among the plurality of digital twin models with the hierarchical data set, and train the classification model based on the generated training data set.

5. The apparatus of claim 4,
wherein the preprocessing unit assigns the training data set with a plurality of test weight sets, and
the training unit inputs a plurality of training data sets assigned with the plurality of test weight sets into the classification model and trains the classification model to derive an optimum coefficient value.

6. The apparatus of claim 5,
wherein the preprocessing unit derives a training data set corresponding to the optimum coefficient value among the plurality of training data sets assigned with the plurality of test weight sets, and sets a test weight set assigned to the derived training data set as an optimum weight set for a digital twin model corresponding to class information included in the derived training data set.

7. The apparatus of claim 6,
wherein the preprocessing unit sets an optimum weight set for each of the plurality of digital twin models.

8. A method for deriving a digital twin model, which is performed by an apparatus configured to drive a digital twin model, comprising:
a process of collecting sensing data from a plurality of sensors mapped to a plurality of digital twin models for a target area to be managed;
a process of generating a hierarchical data set assigned with a weight by performing a preprocessing process on the collected sensing data; and
a process of deriving information about at least one digital twin model corresponding to the hierarchical data set among the plurality of digital twin models by using a pre-trained classification model.

9. The method of claim 8,
wherein the process of generating a hierarchical data set includes a process of assigning the generated hierarchical data set with a plurality of optimum weight sets corresponding to the plurality of digital twin models, and
the process of deriving information about at least one digital twin model includes a process of inputting the hierarchical data set assigned with the optimum weight sets into the classification model.

10. The method of claim 9,
wherein the process of deriving information about at least one digital twin model includes a process of deriving class information of a digital twin model corresponding to the hierarchical data set assigned with the optimum weight sets among the plurality of digital twin models by using the classification model and a probability value for the digital twin model.

11. The method of claim 8, further comprising:
a process of generating a training data set by combining class information of a digital twin model corresponding to the hierarchical data set among the plurality of digital twin models with the hierarchical data set; and
a process of training the classification model based on the generated training data set.

12. The method of claim 11,
wherein the process of generating a hierarchical data set includes a process of assigning the training data set with a plurality of test weight sets, and
the process of training the classification model includes a process of inputting a plurality of training data sets assigned with the plurality of test weight sets into the classification model and training the classification model to derive an optimum coefficient value.

13. The method of claim 12,
wherein the process of generating a hierarchical data set includes:
a process of deriving a training data set corresponding to the optimum coefficient value among the plurality of training data sets assigned with the plurality of test weight sets; and
a process of setting a test weight set assigned to the derived training data set as an optimum weight set for a digital twin model corresponding to class information included in the derived training data set.

14. The method of claim 13,
wherein the process of generating a hierarchical data set includes a process of setting an optimum weight set for each of the plurality of digital twin models.

15. A non-transitory computer-readable medium storing computer program including a sequence of instructions to derive a digital twin model, which when executed by a computing device, causes the computing device to:
collect sensing data from a plurality of sensors mapped to a plurality of digital twin models for a target area to be managed;
generate a hierarchical data set assigned with a weight by performing a preprocessing process on the collected sensing data; and
derive information about at least one digital twin model corresponding to the hierarchical data set among the plurality of digital twin models by using a pre-trained classification model.
